(19) United States
(12) Patent Application Publication
(10) Pub. No.: US 2026/0145175 A1
(43) Pub. Date: May 28, 2026

(54) HIGH POWER IMPULSE CRUSHING TOOL AND METHOD

(71) Applicant: I-ROX, TOULOUSE (FR)

(72) Inventors: Romain PECQUOIS, TOULOUSE (FR); Julien DEROY, TOULOUSE (FR)

(73) Assignee: I-ROCK, TOULOUSE (FR)

(21) Appl. No.: 19/122,133

(22) PCT Filed: Sep. 19, 2023
(86) PCT No.: PCT/EP2023/075715

§ 371 Date: Apr. 17, 2025

(30) Foreign Application Priority Data
Oct. 26, 2022 (FR) 2211163

(51) Int. Cl. B02C 19/18

(52) U.S. Cl. CPC B02C 19/18; B02C 2019/183

(57) ABSTRACT

The invention relates to a tool (1) for crushing rock by high power impulses, comprising at least one energy recovery module (30-1) comprising at least one capacitor (C1, C2, C3) and a secondary pair of electrodes (30-1A, 30-1B), the at least one capacitor (C1) of the first energy recovery module (30-1) being electrically connected to the second electrode (20B) of a main pair of electrodes (20A, 20B) as well as to the ground (M), the secondary pair of electrodes (30-1A, 30-1B) comprising a first electrode (30-1A), electrically connected to the midpoint (M1) located between the second electrode (20B) of the main pair of electrodes (20A, 20B) and the at least one capacitor (C1), and a second electrode (30-1B), placed facing the first electrode (30-1A) of the secondary pair of electrodes (30-1A, 30-1B) while being spaced apart by a second inter-electrode distance (D2) and electrically connected to the ground (M).

### TECHNICAL FIELD

The present invention relates to the field of crushing by high power impulses and more particularly concerns a crushing tool by high power impulses and a high power impulse crushing method.

### PRIOR ART

The rock crushing by high power impulses consists of placing a piece of rock between two electrodes and applying a high voltage, for example of the order of a few kilovolts to a few hundred kilovolts, in order to cause a very short electrical discharge, for example of the order of a microsecond. Such a discharge generates tensile and compressive shock stresses that effectively dislocate and crush the rock.

In existing crushing tool solutions, an example of which is described in the document U.S. Pat. No. 4,540,127, the tool comprises a generator electrically connected to two electrodes. FIG. 1 shows the electrical diagram of such a tool 200. The generator 210 comprises an equivalent capacitor 211, representing the high-voltage source and which is connected to a ground M, an equivalent resistor 212 electrically connected in series to the equivalent capacitor 211, an equivalent inductance 213 electrically connected in series to the equivalent resistor 212, and a bi-position switch 214 electrically connected in series on the one hand to the equivalent inductance 213 and on the other hand to a first electrode 215 of the pair of electrodes, the second electrode 216 of the pair of electrodes being electrically connected to the ground M.

When the bi-position switch 214 of the generator 210 closes, an electric discharge is generated in the space between the electrodes 215, 216, commonly referred as the inter-electrode gap, wherein there is a liquid and/or a solid. The electrical discharge creates a plasma which causes a pressure wave in the liquid and/or the solid.

However, the resistance of the load constituted by said liquid and/or solid may change significantly over time, resulting in a loss of energy insofar as a large proportion of the energy, referred as undissipated energy, typically between 50 % and 80 % of the total energy of the applied voltage, is not transformed into the shock wave.

So there's a need for a simple, effective solution that at least partially remedies these disadvantages.

### SUMMARY OF THE INVENTION

To this end, the first object of the invention is a tool for crushing rock by high power impulses, said tool comprising a generator and a main pair of electrodes, said generator comprising a high voltage source electrically connected on the one hand to the ground and on the other hand in series at least with a bi-position switch, said switch being electrically connected to a first electrode of the main pair of electrodes, the second electrode of the main pair of electrodes being placed facing the first electrode and being spaced apart by a distance referred to as the “inter-electrode distance”, the tool being characterized in that it comprises at least one energy recovery module comprising at least one capacitor and a secondary pair of electrodes, the at least one capacitor of the first energy recovery module being electrically connected, on the one hand, to the second electrode of the main pair of electrodes and, on the other hand, to the ground, the secondary pair of electrodes of the first energy recovery module comprising a first electrode electrically connected to the midpoint located between the second electrode of the main pair of electrodes and the at least one capacitor, and a second electrode, placed facing the first electrode of the secondary pair of electrodes while being spaced apart by a second inter-electrode distance and electrically connected to the ground.

At least one capacitor allows to recover the un-dissipated energy from the first discharge in order to trigger a second discharge (and so on depending on the number of energy recovery modules used) and thus prevent this portion of energy from being dissipated and lost in the electrical circuit. Moreover, by triggering several electrical discharges, the tool is effective at crushing the rock. The tool according to the invention is particularly suitable for configurations where the generator is not electrically adapted to the load. The use of a switch allows to ensure a rapid rise in voltage at the terminals of the electrodes of the main pair of electrodes.

One or more energy recovery modules may be used in cascade. More specifically, the tool may comprise N energy recovery modules, where N is a natural number greater than or equal to one. The high-voltage source of the tool must be calibrated so that the un-dissipated voltage collected by the at least one capacitor allows a voltage greater than or equal to the breakdown threshold of the secondary pair of electrodes to be redefined, and so on when several energy recovery modules are connected in cascade. For example, the voltage delivered by the high voltage source must be chosen so that at least 80 % of its value, which corresponds to the voltage defined by the collection of energy in the at least one capacitor of the first energy recovery module, constitutes a value greater than the breakdown threshold of the electrodes of the secondary pair of electrodes.

In one embodiment, the tool comprises a single energy recovery module.

In another embodiment, the tool comprises a plurality of energy recovery modules connected in cascade to improve the efficiency of the tool.

Advantageously, the tool comprises a second energy recovery module comprising at least one capacitor and a secondary pair of electrodes, said at least one capacitor of said second energy recovery module being electrically connected, on the one hand, to the second electrode of the secondary pair of electrodes of the first energy recovery module and, on the other hand, to the ground, the secondary pair of electrodes of the second energy recovery module comprising a first electrode, electrically connected to the midpoint located between the second electrode of the secondary pair of electrodes of the first energy recovery module and the at least one capacitor of the second energy recovery module, and a second electrode, placed facing the first electrode of the secondary pair of electrodes of the second energy recovery module, being spaced apart by a third inter-electrode distance and electrically connected to the ground.

Advantageously still, the tool comprises a third energy recovery module comprising at least one capacitor and a secondary pair of electrodes, the at least one capacitor of said third energy recovery module being electrically connected on the one hand to the second electrode of the secondary pair of electrodes of the second energy recovery module and on the other hand to the ground, the secondary pair of electrodes of the third energy recovery module comprising a first electrode, electrically connected to the midpoint located between the second electrode of the secondary pair of electrodes of the second energy recovery module and the at least one capacitor of the third energy recovery module, and a second electrode, placed facing the first electrode of the secondary pair of electrodes of the third energy recovery module while being spaced apart by a fourth inter-electrode distance and electrically connected to the ground.

In one embodiment, the at least one capacitor of an energy recovery module comprises a single capacitor.

In another embodiment, the at least one capacitor of an energy recovery module comprises a plurality of capacitors connected in series and/or in parallel.

In one embodiment, each energy recovery module comprises a switch, for example a bi-position switch, connected between the at least one capacitor and the first electrode of the secondary pair of electrodes so as to allow the total discharge of said at least one capacitor while preventing charging of the at least one capacitor of the next energy recovery module (in the cascade connection).

In one embodiment, each energy recovery module comprises an inductor, for example a coil, connected between the at least one capacitor and the first electrode of the secondary pair of electrodes.

According to one aspect of the invention, the voltage delivered by the generator is between 1 and 300 kV, preferably between 50 and 300 kV, and even more preferably around 180 kV.

The invention also relates to a method for recovering high power impulse energy for rock crushing, said method comprising the steps of:
controlling a first electrical discharge between a first electrode and a second electrode of a main pair of electrodes,
recovering a part of the energy of the first electrical discharge by at least one capacitor connected between the second electrode of the main pair of electrodes and a ground,
triggering a second electrical discharge between a first electrode and a second electrode of a secondary pair of electrodes.

In one embodiment, the method further comprises a step of recovering a part of the energy of the second electrical discharge by at least one second capacitor connected between the second electrode of the secondary pair of electrodes and the ground.

In one embodiment, the method further comprises triggering a third electrical discharge between a first electrode and a second electrode of a secondary pair of electrodes of a second energy recovery module.

In one embodiment, the method further comprises a step of recovering a part of the energy of the third electrical discharge by at least one third capacitor connected between the second electrode of the secondary pair of electrodes of the second energy recovery module and the ground.

In one embodiment, the method further comprises triggering a fourth electrical discharge between a first electrode and a second electrode of a secondary pair of electrodes of a third energy recovery module.

### BRIEF DESCRIPTION OF FIGURES

Other characteristics and advantages of the invention will become apparent from the description the following description. This is purely illustrative and should be read in conjunction with the attached drawings wherein:

FIG. 1 schematically illustrates one embodiment of a prior art system.

FIG. 2 schematically illustrates a first embodiment of the system according to the invention.

FIG. 3 schematically illustrates a second embodiment of the system according to the invention.

FIG. 4 schematically illustrates a third embodiment of the system according to the invention.

FIG. 5 Schematically illustrates a fourth embodiment of the system according to the invention.

FIG. 6 Schematically illustrates a fifth embodiment of the system according to the invention.

FIG. 7 Schematically illustrates a sixth embodiment of the system according to the invention.

FIG. 8 Schematically illustrates a first embodiment of the method according to the invention.

FIG. 9 Schematically illustrates a second embodiment of the method according to the invention.

FIG. 10 schematically illustrates a third embodiment of the method according to the invention.

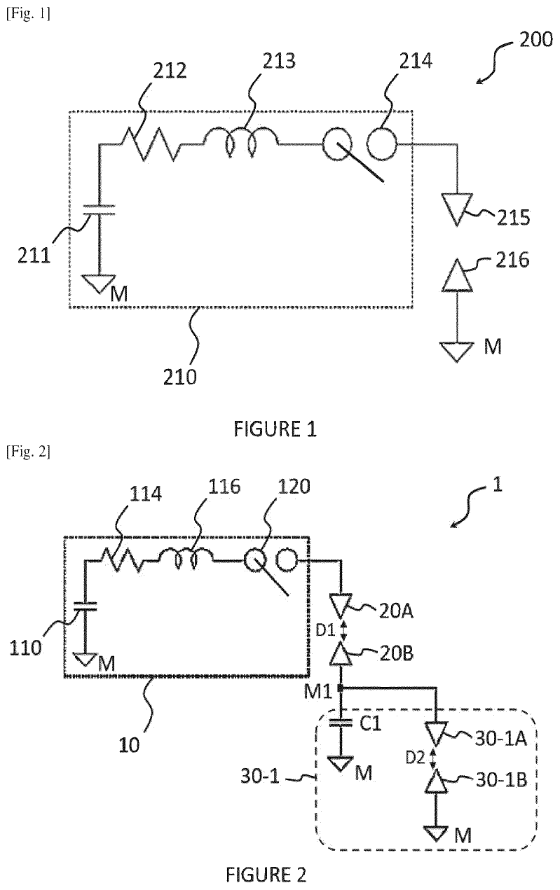

### DESCRIPTION OF THE EMBODIMENTS

### Tool 1

FIGS. 2 to 4 illustrate three examples of the electrical diagram of a high-power impulse rock crushing tool 1 according to the invention.

The tool 1 comprises a generator 10, a main pair of electrodes 20A, 20B and at least one energy recovery module 30-1, 30-2, 30-3.

The generator 10 comprises a high-voltage source 110 electrically connected on the one hand to a ground M and on the other hand in series with at least one bi-position switch 120. An equivalent resistor 114 and an equivalent inductor 116 are electrically connected in series between the high voltage source 110 and the switch 120.

The voltage delivered by the high voltage source 110 is between 1 and 300 kV, preferably between 50 and 300 kV, for example between 170 and 200 kV.

The switch 120 is electrically connected to the first electrode 20A of the main pair of electrodes 20A, 20B.

The second electrode 20B of the main pair of electrodes 20A, 20B is placed facing the first electrode 20A of the main pair of electrodes 20A, 20B and being spaced apart by a distance D1 referred to as the “inter-electrode” distance 20A, 20B.

Each energy recovery module 30-1, 30-2, 30-3 comprises at least one capacitor C1, C2, C3 and a pair of electrodes (30-1A, 30-1B), (30-2A, 30-2B), (30-3A, 30-3B). Each capacitor C1, C2, C3 recovers a part of the energy generated by the discharge of the pair of electrodes to which it is connected (20A, 20B), (30-1A, 30-1B), (30-2A, 30-2B) in order to prevent this energy from being lost through dissipation in the electrical circuit. The at least one capacitor C1, C2, C3 is a single capacitor or comprises one or more capacitors connected in series and/or in parallel, electrically equivalent to a single equivalent capacitor.

In the following, for the sake of clarity, each energy recovery module 30-1, 30-2, 30-3 comprises a single capacitor C1, C2, C3.

### Example 1

In the example shown in FIG. 2, the tool 1 comprises a first and single energy recovery module 30-1.

The first energy recovery module 30-1 comprises a capacitor C1 and a pair of electrodes 30-1A, 30-1B.

The capacitor C1 is electrically connected on the one hand to the second electrode 20B of the main pair of electrodes 20A, 20B and on the other hand to the ground M.

The pair of electrodes 30-1A, 30-1B of the first energy recovery module 30-1 comprises a first electrode 30-1A electrically connected to a midpoint M1 located between the second electrode 20B of the main pair of electrodes 20A, 20B and the capacitor C1.

The pair of electrodes 30-1A, 30-1B of the first energy recovery module 30-1 also comprises a second electrode 30-1B placed facing the first electrode 30-1A and spaced apart by a second inter-electrode distance D2 and electrically connected to the ground M.

### Example 2

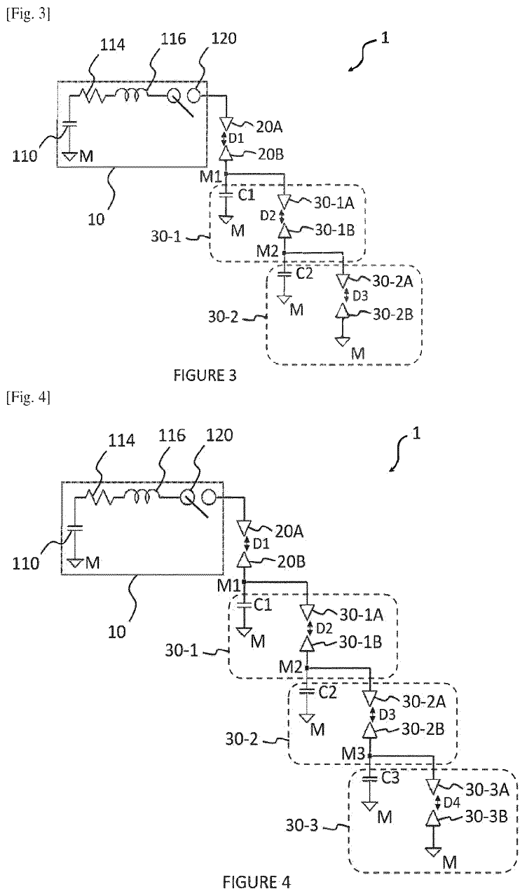

In the example shown in FIG. 3, the tool 1 comprises two energy recovery modules 30-1, 30-2 connected in cascade.

The first energy recovery module 30-1 is identical to that shown in the example 1.

The second energy recovery module 30-2 comprises a capacitor C2 and a pair of electrodes 30-2A, 30-2B.

The capacitor C2 is electrically connected on the one hand to the second electrode 30-1B of the pair of electrodes 30-1A, 30-1B of the first energy recovery module 30-1 and on the other hand to ground M.

The pair of electrodes 30-2A, 30-2B of the second energy recovery module 30-2 comprises a first electrode 30-2A electrically connected to a midpoint M2 located between the second electrode 30-1B of the pair of electrodes 30-1A, 30-1B of the first energy recovery module 30-1 and the capacitor C2.

The pair of electrodes 30-2A, 30-2B of the second energy recovery module 30-2 also comprises a second electrode 30-2B placed facing the first electrode 30-2A and spaced apart by a third inter-electrode distance D3 and electrically connected to the ground M.

### Example 3

In the example shown in FIG. 4, the tool 1 comprises three energy recovery modules 30-1, 30-2, 30-3 connected in cascade.

The first energy recovery module 30-1 is identical to the first energy recovery module 30-1 of the examples 1 and 2. The second energy recovery module 30-2 is identical to the second energy recovery module 30-2 of the example 2.

The third energy recovery module 30-3 comprises a capacitor C3 and a pair of electrodes 30-3A, 30-3B.

The capacitor C3 is electrically connected on the first hand to the second electrode 30-2B of the pair of electrodes 30-2A, 30-2B of the second energy recovery module 30-2 and on the other hand to the ground M.

The pair of electrodes 30-3A, 30-3B of the third energy recovery module 30-3 comprises a first electrode 30-3A electrically connected to a midpoint M3 located between the second electrode 30-2B of the pair of electrodes 30-2A, 30-2B of the second energy recovery module 30-2 and the capacitor C3.

The pair of electrodes 30-3A, 30-3B of the third energy recovery module 30-3 also comprises a second electrode 30-3B placed facing the first electrode 30-3A and spaced apart by a fourth inter-electrode distance D4 and electrically connected to the ground M.

In other embodiments, the tool 1 according to the invention may comprise more than three energy recovery modules 30-1, 30-2, 30-3.

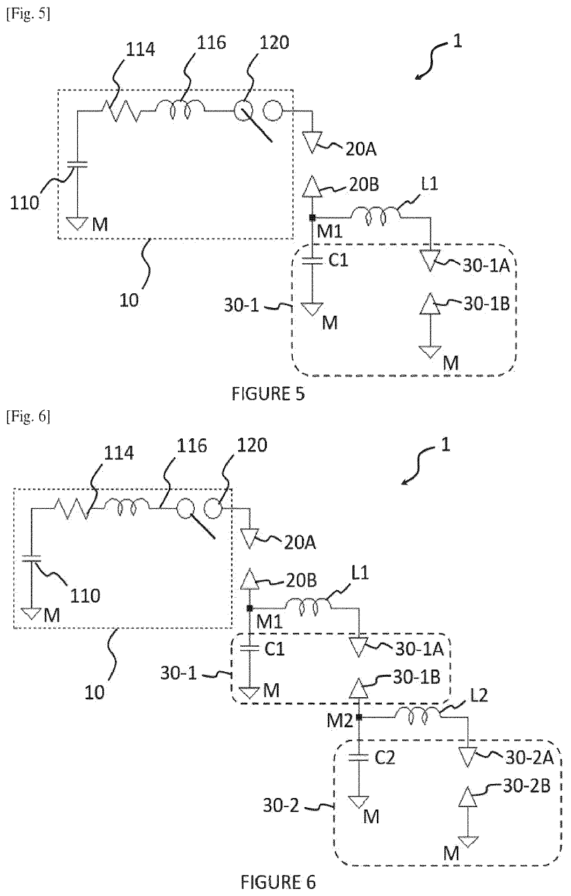

FIGS. 5 to 7 illustrate three further embodiments.

In the example shown in FIG. 5, the diagram of the tool 1 is identical to that in FIG. 2 but a coil L1 has been added between the midpoint M1 and the first electrode 30-1A of the pair of electrodes 30-1A, 30-1B of the first energy recovery module 30-1. This coil L1 may, for example, be a discrete element or any suitable inductive element. The purpose of the coil L1 is to make the voltage resonate when energy is transferred between the capacitor C1 and the capacitor C2, so that the capacitor C2 is charged to the same voltage as the capacitor C1.

In the example shown in FIG. 6, the diagram of the tool 1 is identical to that in FIG. 3, but a coil L1 has been added between the midpoint M1 and the first electrode 30-1A of the pair of electrodes 30-1A, 30-1B of the first energy recovery module 30-1 and a coil L2 has been added between the midpoint M2 and the first electrode 30-2A of the pair of electrodes 30-2A, 30-2B of the second energy recovery module 30-2. The coils L1 and L2 may, for example, be discrete elements or any type of suitable inductive element. The purpose of the coils L1 and L2 is to make the voltage resonate during the transfer of energy between the capacitor of the previous module and the capacitor of the next module in order to charge the capacitor of the next module to the same voltage as that of the capacitor of the previous module.

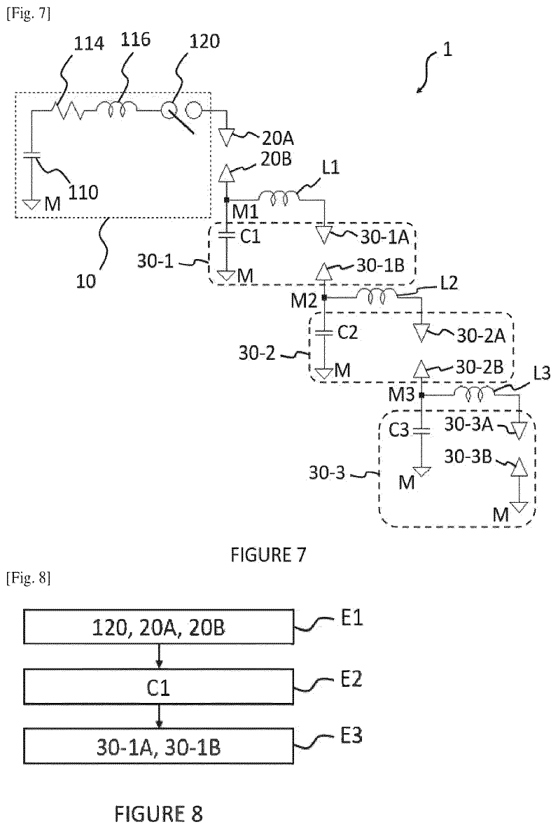

In the example shown in FIG. 7, the diagram of the tool 1 is identical to that in FIG. 4, but a coil L1 has been added between the midpoint M1 and the first electrode 30-1A of the pair of electrodes 30-1A, 30-1B of the first energy recovery module 30-1, a coil L2 was added between the midpoint M2 and the first electrode 30-2A of the pair of electrodes 30-2A, 30-2B of the second energy recovery module 30-2 and a coil L3 was added between the midpoint M3 and the first electrode 30-3A of the pair of electrodes 30-3A, 30-3B of the third energy recovery module 30-3. The coils L1, L2 and L3 may, for example, be discrete elements or any type of suitable inductive element. The purpose of the coils L1, L2 and L3 is to make the voltage resonate during the transfer of energy between the capacitor of the previous module and the capacitor of the next module so as to charge the capacitor of the next module to the same voltage as that of the capacitor of the previous module.

### EXAMPLES OF IMPLEMENTATION

### First Embodiment

This first embodiment relates to example 1 and is described with reference to FIG. 8.

Firstly, as a prerequisite, a piece of rock is placed in the tool so that it extends between each pair of electrodes (20A, 20B), (30-1A, 30-1B).

In a step E1, the switch 120 is controlled to close in order to apply the voltage from the high voltage source 110 between the first electrode 20A and the second electrode 20B of the main pair of electrodes 20A, 20B and thus cause a first electrical discharge in the rock, said voltage being greater than the breakdown threshold.

In a step E2, the capacitor C1 then recovers some of the energy from the first electrical discharge, which, when the voltage at the terminals of the capacitor C1 reaches the charging threshold, causes a second electrical discharge in the rock between the first electrode 30-1A and the second electrode 30-1B of the pair of electrodes 30-1A, 30-1B of the first energy recovery module 30-1 in a step E3,

The switch 120 is then controlled to open in order to prepare for the next shot at the level of the electrodes 20A, 20B.

### Second Embodiment

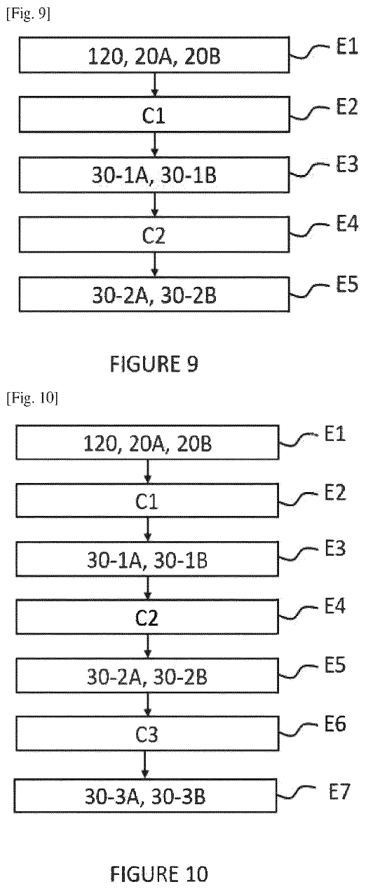

This second embodiment relates to the example 2 and is described with reference to FIG. 9.

Firstly, a piece of rock is placed in the tool between each pair of electrodes (20A, 20B), (30-1A, 30-1B), (30-2A, 30-2B). These pieces of rock may be different. For example, a conveyor on which the pieces of rock circulate may be used and the pairs of electrodes placed around the conveyor at different axial positions.

In a step E1, the switch 120 is controlled to close in order to apply the voltage from the high voltage source 110 between the first electrode 20A and the second electrode 20B of the main pair of electrodes 20A, 20B and thus cause a first electrical discharge in the rock, said voltage being greater than the breakdown threshold.

In a step E2, the capacitor C1 then recovers a part of the energy from the first electrical discharge., which leads, when the voltage at the terminals of the capacitor C1 reaches the charging threshold, to a second electrical discharge in the rock between the first electrode 30-1A and the second electrode 30-1B of the pair of electrodes 30-1A, 30-1B of the first energy recovery module 30-1 in a step E3.

Then, in a step E4, the capacitor C2 recovers a part of the energy from the second electrical discharge, which, when the voltage at the terminals of the capacitor C2 reaches the charging threshold, causes a third electrical discharge in the rock between the first electrode 30-2A and the second electrode 30-2B of the pair of electrodes 30-2A, 30-2B of the second energy recovery module 30-2 in a step E5.

The switch 120 is then controlled to open to prepare for the next shot at level of the electrodes 20A, 20B.

### Third embodiment

This third embodiment relates to example 3 and is described with reference to the FIG. 10

Firstly, as a prerequisite, a piece of rock is placed in the tool so that it extends between each pair of electrodes (20A, 20B), (30-1A, 30-1B), (30-2A, 30-2B), (30-3A, 30-3B).

In a step E1, the switch 120 is controlled to close in order to apply the voltage from the high voltage source 110 between the first electrode 20A and the second electrode 20B of the main pair of electrodes 20A, 20B and thus cause a first electrical discharge in the rock, said voltage being greater than the breakdown threshold.

In a step E2, the capacitor C1 then recovers a part of the energy from the first electrical discharge, which, when the voltage at the terminals of the capacitor C1 reaches the charging threshold, leads to a second electrical discharge in the rock between the first electrode 30-1A and the second electrode 30-1B of the pair of electrodes 30-1A, 30-1B of the first energy recovery module 30-1 in a step E3.

Then, in a step E4, the capacitor C2 recovers a part of the energy from the second electrical discharge, which, when the voltage at the terminals of the capacitor C2 reaches the charging threshold, leads to a third electrical discharge in the rock between the first electrode 30-2A and the second electrode 30-2B of the pair of electrodes 30-2A, 30-2B of the second energy recovery module 30-2 in a step E5.

Then, in a step E6, the capacitor C3 recovers a part of the energy from the third electrical discharge, which, when the voltage at the terminals of the capacitor C3 reaches the charging threshold, leads to a fourth electrical discharge in the rock between the first electrode 30-3A and the second electrode 30-3B of the pair of electrodes 30-3A, 30-3B of the third energy recovery module 30-3 in a step E7.

The switch 120 is then control to open in order to prepare for the next shot at the level of the electrodes 20A, 20B.

It goes without saying that, in order to be able to trigger the cascade electrical discharges, each capacitor C1, C2, C3 of each energy recovery module 30-1, 30-2, 30-3 must be sized so as to be able to store a quantity of energy defining a voltage at least equal to the breakdown threshold between the electrodes of the pair of electrodes of said energy recovery module 30-1, 30-2, 30-3.

With the tool and the method according to the invention, each capacitor C1, C2, C3 of each energy recovery module 30-1, 30-2, 30-3 collects a part of the energy not dissipated during breakdown between the electrodes of the pair of electrodes located upstream, which allows to cause an electrical discharge between the electrodes of the pair of electrodes located downstream of said capacitor C1, C2, C3. The tool and the method according to the invention therefore allow to recycle a part of the energy not dissipated by an electrical discharge between electrodes of a pair of upstream electrodes to prevent it from being lost.

In another embodiment, each energy recovery module 30-1, 30-2, 30-3 may comprise a switch connected between the capacitor and the first electrode of the secondary pair of electrodes of said module which would be controlled so as to allow the full discharge of said capacitor avoiding the charge of the capacitor of the next energy recovery module (in the cascade connection). More precisely, a switch, initially open, is controlled to close when the voltage in the capacitor is at its maximum, which corresponds to the maximum stored energy.

The invention therefore allows to optimize the use of breakdown energy between the electrodes by recovering a part of the dissipated energy for reuse.

1-15. (canceled)

16. A tool for crushing rock by high power impulses, said too comprising a generator and a main pair of electrodes, said generator comprising a high voltage source electrically connected on the one hand to the ground and on the other hand in series at least with a bi-position switch, said switch being electrically connected to a first electrode of the main pair of electrodes, the second electrode of the main pair of electrodes being placed facing the first electrode and being spaced apart by a distance referred to as the “inter-electrode distance””, the tool comprises at least one energy recovery module comprising at least one capacitor and a secondary pair of electrodes, the at least one capacitor of the first energy recovery module being electrically connected on the one hand to the second electrode of the main pair of electrodes and on the other hand to the ground, the secondary pair of electrodes of the first energy recovery module comprising a first electrode, electrically connected at the midpoint located between the second electrode of the main pair of electrodes and the at least one capacitor, and a second electrode, placed facing the first electrode of the secondary pair of electrodes while being spaced apart by a second inter-electrode distance and electrically connected to the ground.

17. The tool according to claim 16, comprising a single energy recovery module.

18. The tool according to claim 16, comprising a plurality of energy recovery modules connected in cascade.

19. The tool according to claim 18, comprising a second energy recovery module comprising at least one capacitor and a secondary pair of electrodes, said at least one capacitor of said second energy recovery module being electrically connected on the one hand to the second electrode of the secondary pair of electrodes of the first energy recovery module and on the other hand to the ground, the secondary pair of electrodes of the second energy recovery module comprising a first electrode, electrically connected to the midpoint located between the second electrode of the secondary pair of electrodes of the first energy recovery module and the at least one capacitor of the second energy recovery module, and a second electrode, placed facing the first electrode of the secondary pair of electrodes of the second energy recovery module being spaced apart by a third inter-electrode distance and electrically connected to the ground.

20. The tool according to claim 19, comprising a third energy recovery module comprising at least one capacitor and a secondary pair of electrodes, said at least one capacitor of the third energy recovery module being electrically connected on the one hand to the second electrode of the secondary pair of electrodes of the second energy recovery module and on the other hand to the ground, the secondary pair of electrodes of the third energy recovery module comprising a first electrode, electrically connected to the midpoint located between the second electrode of the secondary pair of electrodes of the second energy recovery module and the at least one capacitor of the third energy recovery module, and a second electrode, placed facing the first electrode of the secondary pair of electrodes of the third energy recovery module being spaced apart by a fourth inter-electrode distance and electrically connected to the ground.

21. The tool according to claim 16, wherein each of an energy recovery module comprises a single capacitor.

22. The tool according to claim 16, wherein each of an energy recovery module comprises a plurality of capacitors connected in series and/or in parallel.

23. The tool according to claim 16, wherein at least one of the energy recovery modules comprises a coil connected between the at least one capacitor and the first electrode of the secondary pair of electrodes.

24. The tool according to claim 16, wherein each energy recovery module comprises a switch connected between the at least one capacitor and the first electrode of the secondary pair of electrodes of said module.

25. The tool according to claim 16 wherein the voltage delivered by the generator is between 1 and 300 kV.

26. A method for recovering high power impulse energy for rock crushing, said method comprising the steps of:
controlling a first electrical discharge between a first electrode and a second electrode of a main pair of electrodes,
recovering a part of the energy of the first electrical discharge by at least one capacitor connected between the second electrode of the main pair of electrodes and a ground,
triggering a second electrical discharge between a first electrode and a second electrode of a secondary pair of electrodes of a first energy recovery module.

27. The method according to claim 26, said method further comprising a step of recovering a part of the energy of the second electrical discharge by at least one second capacitor connected between the second electrode of the secondary pair of electrodes of the first energy recovery module and the ground.

28. The method according to claim 26, said method further comprising triggering a third electrical discharge between a first electrode and a second electrode of a secondary pair of electrodes of a second energy recovery module.

29. The method according to claim 26, said method further comprising a step of recovering a part of the energy of the third electrical discharge by at least one third capacitor connected between the second electrode of the secondary pair of electrodes of the second energy recovery module and the ground.

30. The method according to claim 26, said method further comprising triggering a fourth electrical discharge between a first electrode and a second electrode of a secondary pair of electrodes of a third energy recovery module.
